(19) United States
(12) Patent Application Publication
(10) Pub. No.: US 2025/0372736 A1
(43) Pub. Date: Dec. 4, 2025

(54) Self-Destructive Code Device for a Rechargeable Battery Device

(71) Applicant: Google LLC, Mountain View, CA (US)

(72) Inventors: David Wang, San Jose, CA (US); James Robert Lim, Mountain View, CA (US); Sheba Devan, Pleasanton, CA (US)

(73) Assignee: Google LLC, Mountain View, CA (US)

(21) Appl. No.: 19/223,825

(22) Filed: May 30, 2025

Related U.S. Application Data
(60) Provisional application No. 63/654,495, filed on May 31, 2024.

(51) Int. Cl. H01M 10/42; H01M 50/572

(52) U.S. Cl. CPC H01M 10/4257; H01M 50/572; H01M 2200/20

(57) ABSTRACT

This document describes systems and techniques for a self-destructive code device for a rechargeable battery device. For example, a system comprises a rechargeable battery device certified for use with an electronic device. An authentication code is associated with the rechargeable battery device to validate that the rechargeable battery device is authenticated for use with the electronic device. A self-destructive code device is attachable to the rechargeable battery device, the self-destructive code device being configured to present the authentication code and cause the authentication code to become unusable after that rechargeable battery device is deployed for use with the electronic device.

### SUMMARY

This document describes systems and techniques for a self-destructive code device for a rechargeable battery device. When an electronic device allows for replaceable rechargeable battery packs, it may be desirable to authenticate that a rechargeable battery device meets quality and performance standards and/or is not a recycled or reworked battery pack that may not meet those quality and performance standards. Associating a rechargeable battery device with a self-destructive code device that can be validated by an authentication system may ensure that neither the electronic device nor its user is harmed by a non-original equipment manufacturer (non-OEM) rechargeable battery device that may overheat, leak, and/or rupture in the course of ordinary use with the electronic device. Presenting a self-destructive code device may protect against attempts to reuse an authentication code to validate a non-certified rechargeable battery device.

For example, a system comprises a rechargeable battery device certified for use with an electronic device. An authentication code is associated with the rechargeable battery device to validate that the rechargeable battery device is authenticated for use with the electronic device. A self-destructive code device is attachable to the rechargeable battery device, the self-destructive code device being configured to present the authentication code and cause the authentication code to become unusable after that rechargeable battery device is deployed for use with the electronic device.

This Summary is provided to introduce systems and techniques for a self-destructive code device for a rechargeable battery device, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques for a self-destructive code device for a rechargeable battery device are described in this document with reference to the following Drawings. The same numbers are used throughout the drawings to reference like features and components.

FIG. 1 is a schematic diagram of a system in which an authentication code is presented by a self-destructive code device used to validate a rechargeable battery device for use with an electronic device;

FIGS. 2A-2D are cross-sectional views of an implementation of the self-destructive code device of FIG. 1;

FIGS. 3A-3D are perspective views of another implementation of the self-destructive code device of FIG. 1;

FIGS. 4A and 4B are cross-sectional views of alternative forms of cover layers for covering the self-destructive code device of FIG. 1;

FIGS. 5A-5C are diagrams of machine-readable codes usable as authentication codes with the self-destructive code device of FIG. 1;

FIG. 6 is a schematic diagram of a system in which the self-destructive code device of FIG. 1 and additional authentication codes are used to validate a rechargeable battery device;

FIGS. 7A and 7B are schematic diagrams of rechargeable battery devices supporting the self-destructive code device and additional authentication codes of FIG. 6; and

FIG. 8 is a flow diagram of managing the functionality of a rechargeable battery device according to one or more authentication codes presented.

### DETAILED DESCRIPTION

### Overview

Mobile telephones and other electronic devices depend on efficient rechargeable battery devices. Further, to be able to extend the use of electronic devices between charges and/or to be able to continue to use these devices when an original rechargeable battery device may no longer be able to perform, it may be desirable to enable users to replace an exhausted rechargeable battery device with a new rechargeable battery device. However, use of a non-OEM device that does not meet to design requirements or quality controls may result in the rechargeable battery device overheating, expanding, leaking, or causing other problems that may damage the electronic device or cause harm to the user. Thus, even when “right to repair” regulations or other considerations allow for replacement of a rechargeable battery device, electronic device manufacturers may want to ensure that only authentic replacement rechargeable battery devices are used.

Various techniques exist for attempting to restrict the use of non-certified rechargeable battery devices. Some manufacturers include mechanical “keys” that block the installation of rechargeable battery devices that are not shaped to fit a particular electronic device, but such keys can be reverse-engineered. Some manufacturers have incorporated authentication circuitry in their rechargeable battery devices and configure electronic devices to only allow use of rechargeable battery devices that properly respond to challenges to the authentication circuitry. However, such authentication circuitry may be costly to implement or may be reverse-engineerable. Manufacturers may assign unique serial numbers to authentic rechargeable battery devices, but non-OEM battery manufacturers may copy these serial numbers to circumvent serial number verification.

In aspects, systems and techniques for a self-destructive code device for a rechargeable battery device provide a cost-effective way for electronics device manufacturers to verify that a rechargeable battery device is authentic but do not allow for an authentication code presented by the self-destructive code device to be copied to authenticate additional devices.

For example, a system comprises a rechargeable battery device certified for use with an electronic device. An authentication code is associated with the rechargeable battery device to validate that the rechargeable battery device is authenticated for use with the electronic device. A self-destructive code device is attachable to the rechargeable battery device, the self-destructive code device being configured to present the authentication code and cause the authentication code to become unusable after that rechargeable battery device is deployed for use with the electronic device.

### Overview of a Self-Destructive Code Device

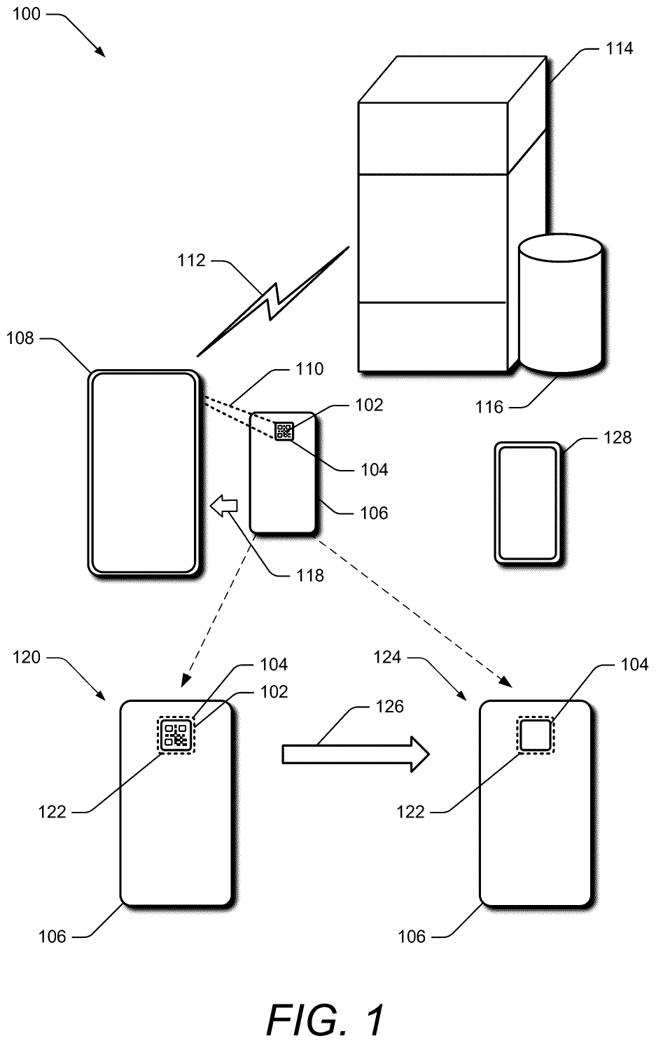

FIG. 1 is a schematic diagram of a system 100 in which an authentication code 102 is presented by a self-destructive code device 104 to authenticate a rechargeable battery device 106 for use in an electronic device 108. The self-destructive code device 104 is attachable to the rechargeable battery device 106 with adhesive or another attachment mechanism. In aspects, the electronic device 108 is used to scan the authentication code 102, as represented by the dotted lines 110. The electronic device 108 then communicates over a network 112 with an authentication system 114. In aspects, the authentication system 114 queries an authentication code database 116 to determine if the authentication code 102 presented by the self-destructive code device 104 is authenticated for use with the electronic device 108. If the authentication system 114 verifies that the authentication code 102 is authenticated for use with the electronic device 108, upon installation (represented by the arrow 118) in the electronic device 108, the electronic device 108 will be authorized to utilize the rechargeable battery device 106 to its full functionality in terms of power consumption, charging rates, or other capabilities. In aspects, the electronic device 108 may be used to authenticate the authentication code 102 of the rechargeable battery device 106 before replacing the rechargeable battery device 106, although a separate mobile telephone or other electronic device 128 may be used to authenticate the authentication code 102 of the electronic device 108.

The self-destructive code device 104 causes the authentication code 102 to be presented so that it may be scanned 110 by the electronic device 108, but then causes the authentication code 102 to become unusable after the rechargeable battery device 106 is deployed for use with the electronic device 108. In a first state 120 in which the rechargeable battery device 106 has been manufactured for use, the self-destructive code device 104 is attached to the rechargeable battery device 106, using adhesive or another attachment mechanism 122 represented in a dotted outline in FIG. 1, and presents the authentication code 102. However, in a second state 124, after the rechargeable battery device 106 has deployed, as represented by an arrow 126, the self-destructive code device 104 no longer presents the authentication code 102 for scanning 110. Therefore, after the deployment 126, the authentication code 102 is no longer usable to authenticate the rechargeable battery device 106 for another electronic device.

Deployment of Rechargeable Battery Device with Self-Destructive Code Device

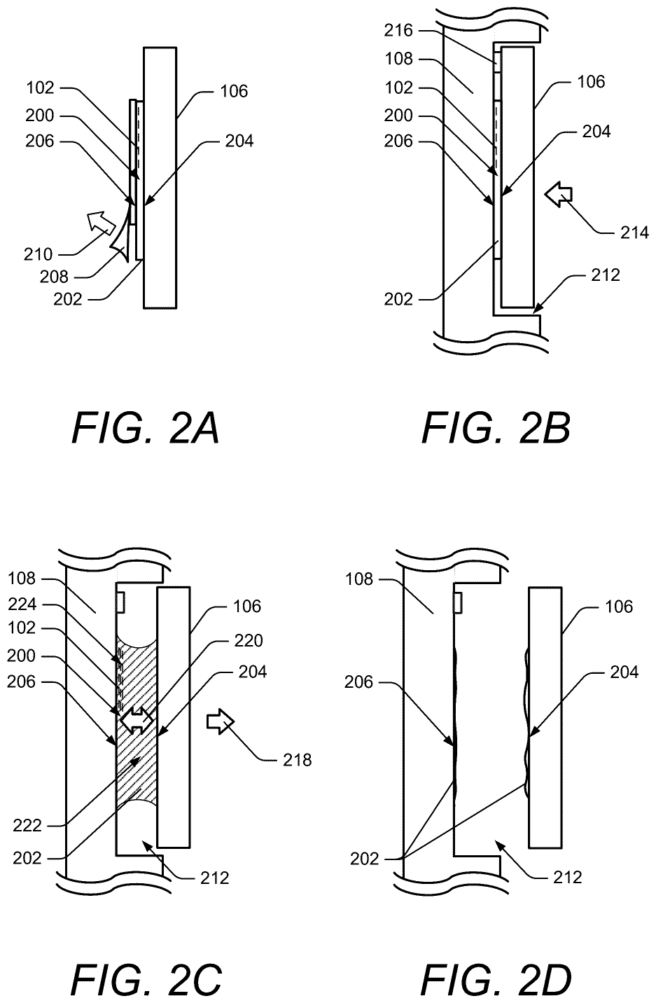

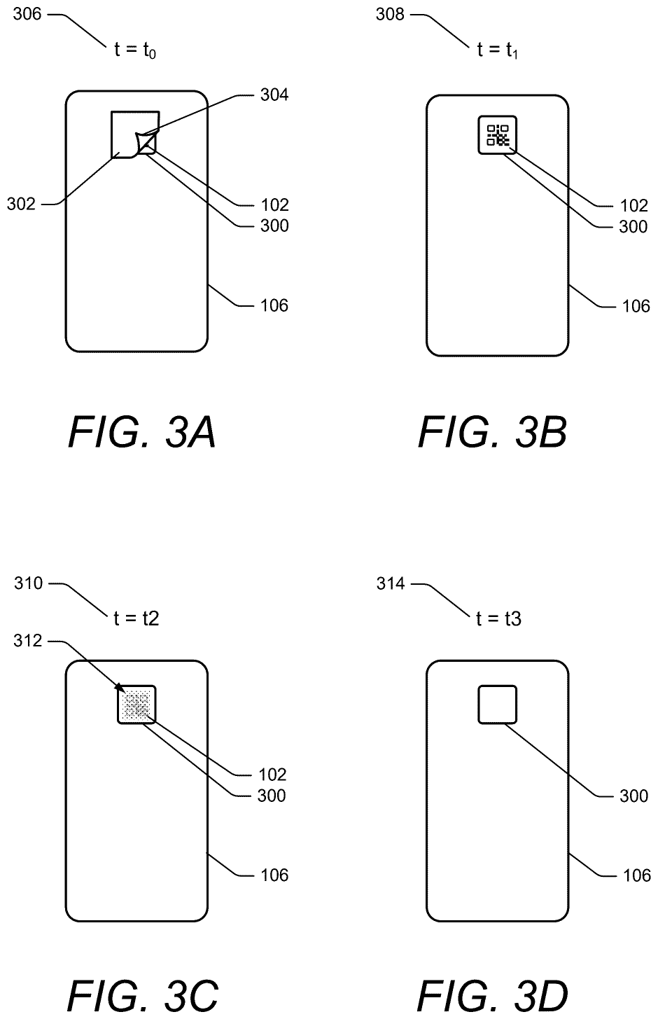

FIGS. 2A-2D and 3A-3D show examples of deployment of self-destructive code devices 200 and 300, respectively, to illustrate how the self-destructive code devices 200 and 300 prevent the authentication code 102 from being usable after deployment. FIGS. 2A-2D are cross-sectional views of the self-destructive code device 200 in which the self-destructive code device 200 includes an adhesive member 202. In aspects, the adhesive member 202 includes a pressure-sensitive adhesive with opposing adhesive surfaces. At an inner surface 204 of the adhesive member 202, the adhesive member 202 is configured to attach the self-destructive code device 200 to the rechargeable battery device 106. An outer surface 206 of the adhesive member 202 presents the authentication code 102 (shown in FIG. 2A as a dashed line) and is configured to attach the rechargeable battery device 106 to a battery compartment of the electronic device 108, as further described below.

Prior to deployment of the self-destructive code device 200, a cover layer 208 is removably attachable to the outer surface 206. The cover layer 208 may include a release liner that is comprised of or coated with a release agent, such as silicone or a similar material, that prevents the adhesive member 202 from adhering to the cover layer 208. To deploy the self-destructive code device 200, the cover layer 208 is removed from the outer surface 206 of the adhesive member 202, such as by peeling away the cover layer 208 from the outer surface 206 of the adhesive member 202 as represented by the arrow 210. With the cover layer 208 removed, the authentication code 102 may be scanned as shown in FIG. 1 to authenticate the rechargeable battery device 106.

FIG. 2B shows the rechargeable battery device 106 deployed within a battery compartment 212 of the electronic device 108. With the cover layer 208 removed as described with reference to FIG. 2A, the rechargeable battery device 106 is inserted and pressed into place in the battery compartment 212 as represented by an arrow 214. With the outer surface 206 of the adhesive member 202 exposed, the adhesive member 202 of the self-destructive code device 200 attaches the rechargeable battery device 206 to the battery compartment 212 of the electronic device 108.

With the rechargeable battery device 106 deployed and/or installed in the battery compartment 212, the rechargeable battery device 106 engages contacts 216 within the battery compartment 212 that electrically and/or mechanically couple the rechargeable battery device 106 with the electronic device 108. Insertion of the rechargeable battery device 106 after removal of a previous rechargeable battery device (not shown) may cause the electronic device 108 to evaluate whether the rechargeable battery device 106 is authenticated for use with the electronic device 108 by verifying the authentication code 102 with the authentication system 114 as previously described with reference to FIG. 1.

Upon being deployed within the battery compartment 212 and adhesively attached to the electronic device 108, the authentication code 102 is covered by and concealed within the electronic device 108. Moreover, if someone wished to remove the rechargeable battery device 206 to attempt to scan the authentication code 102 in an attempt to authenticate another rechargeable battery device (not shown), the self-destructive code device 200 would cause the authentication code 102 to become unusable upon being removed from the electronic device 108.

FIG. 2C shows the rechargeable battery device 106 being removed from the battery compartment 212 as represented by an arrow 218. Pulling the rechargeable battery device 106 from the battery compartment 212 strains the adhesive member 202 of the self-destructive code device 200 as represented by the arrow 220 and a deformed shape 222 of the adhesive member 202. The deformed shape 222 of the adhesive member 202 correspondingly results in a deformed shape 224 of the authentication code 102.

FIG. 2D shows that, upon removing the rechargeable battery device 106 from the battery compartment 212, the adhesive member 202 is torn and/or fragmented. A portion of the inner surface 204 may remain adhered to the rechargeable battery device 106 and a portion of the outer surface 206 may remain adhered to the battery compartment 212. However, in neither case is the authentication code (not shown in FIG. 2D) accessible to someone hoping to view, scan, access, or otherwise use the authentication code in an attempt to authenticate another rechargeable battery device using the same authentication code.

FIGS. 3A-3D show perspective views of another implementation of the self-destructive code device 300. In the example of FIGS. 3A-3D, the self-destructive code device 300 utilizes ink or another medium that causes the authentication code to fade, darken, discolor, and/or disappear after deployment to render the authentication code 102 unusable. FIG. 3A shows the rechargeable battery device 106 supporting the self-destructive code device 300 that is adhesively or otherwise attached to the rechargeable battery device 106. A cover layer 302, like the cover layer 208 of the self-destructive code device 200 (see FIG. 2A) removably covers the self-destructive code device 300 and the authentication code 102, of which only a small portion is visible in FIG. 3A. The cover layer 302 may be peeled or pulled away from the self-destructive code device 300 as represented by the peeled corner 304, similar to the removal of the cover layer 208 of the self-destructive code device 200 of FIG. 2A. FIG. 3A shows the self-destructive code device 300 at a time t=t₀ 306 at which the cover layer 302 is removed or about to be removed from the self-destructive code device 300 to deploy the rechargeable battery device 106.

FIG. 3B shows the self-destructive code device 300 in a deployed condition at a time t=t₁ 308 at which the cover layer 302 has been removed from the self-destructive code layer 300. With the cover layer 302 removed, the authentication code 102 is fully exposed to allow it to be accessed and/or scanned as previously described with FIG. 1.

FIG. 3C shows the self-destructive code device 300 at a time t=t₂ 310 after the self-destructive code device 300 has been deployed and the medium that presents the authentication code 102 begins to fade, darken, discolor, and/or disappear as represented by a shaded area 312. The removal of the cover layer 302 may cause the material of the self-destructive code device 300 or the ink or other medium in which the authentication code 102 is presented to dry out or otherwise react to being exposed to ambient atmosphere.

FIG. 3D shows the self-destructive code device 300 at a time t=t3 314 after the authentication code 102 (not shown in FIG. 3D) is no longer scannable or viewable because of the fading, darkening, discoloring, and/or disappearing of the authentication code 102. The self-destructive code device 300 is shown in FIG. 3D as blank, indicating that the self-destructive code device 300 renders the authentication code 102 no longer usable. Thus, for example, instead of the self-destructive code device 200 causing destruction of the authentication code 102 after deployment in the electronic device 108 after installation (see FIGS. 2A-2D), the self-destructive code device 300 allows a user only a limited amount of time to scan or otherwise use the authentication code 102 to authenticate the rechargeable battery device 106.

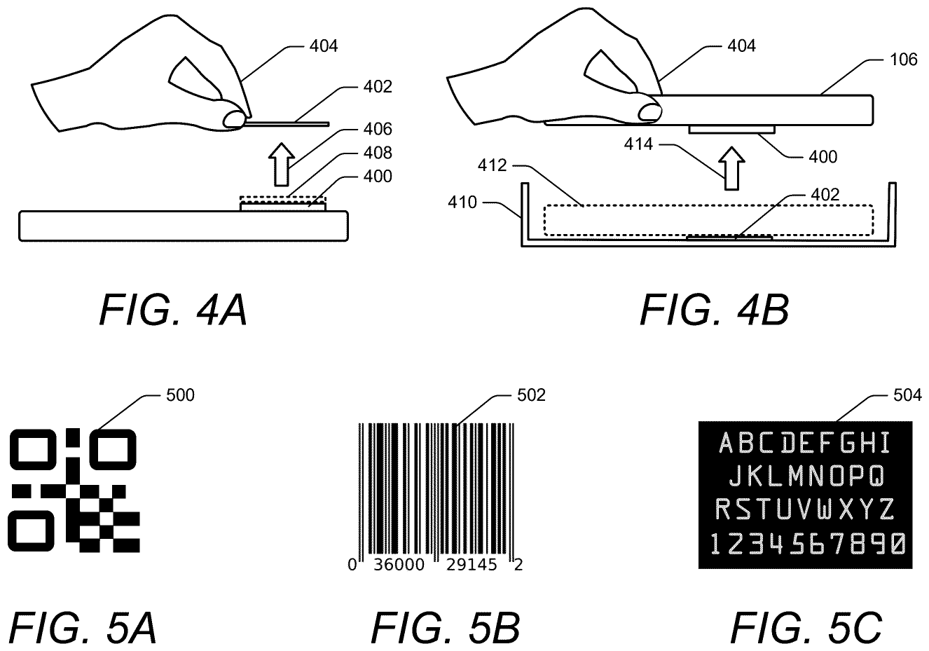

FIGS. 4A and 4B contrast aspects of removing cover layers to expose a self-destructive code device. FIG. 4A shows a cross-sectional view of a self-destructive code device 400 attached to a rechargeable battery device 106. The self-destructive code device 400 may include an adhesive member 202 (see FIGS. 2A-2D) that destroys the authentication code 102 after deployment. Alternatively, the self-destructive code device may include the self-destructive code device 300 that prevents the authentication code 102 from being viewable or scannable after deployment (see FIGS. 3A-3D). In either case, the self-destructive code device 400 is covered by a cover layer 402 that maintains the self-destructive code device 400 in a ready condition prior to deployment when the cover layer 402 is removed from the self-destructive code device 400 and/or the rechargeable battery device 106 is installed in the electronic device 108.

FIG. 4A is a cross-sectional view of a user 404 removing the cover layer 402 from the self-destructive code device 400 on the rechargeable battery device, as represented by an arrow 406. Prior to removal of the cover layer 402, the cover layer 402 was in a pre-deployment position 408 (represented in dotted lines in FIG. 4A) covering the self-destructive code device 400.

In other aspects, the cover layer 402 may be attached to or incorporated in packaging for the rechargeable battery device 106 so that the cover layer is automatically removed from the self-destructive code device 400 when the rechargeable battery device 106 is removed from the packaging. For example, FIG. 4B is a cross-sectional view of the rechargeable battery device 106 being removed from a carrier layer 410 in which the rechargeable battery device 106 is situated during packaging. The self-destructive code device 400 was covered by the cover layer 402 when the rechargeable battery device 106 was secured in the carrier layer 410, as represented by the dotted outline 412. With the cover layer 402 attached to or incorporated in the carrier layer 410, the self-destructive code device 400 is exposed when the rechargeable battery device 106 is deployed by removing it from the carrier layer 410 as represented by the arrow 414. Removal of the rechargeable battery device 106 from the carrier layer 410 removes the self-destructive code device 400 from the cover layer 402, deploying the rechargeable battery device 106.

Alternative and/or Additional Authentication Codes

Multiple different codes may be used as authentication codes. FIG. 5A shows a QR code 500 like that previously used in the authentication code 102 of the preceding examples. However, other forms of scannable or readable codes may be used as authentication codes. For example, FIG. 5B shows a bar code 502 that may be used as an authentication code. FIG. 5C shows an alphanumeric code 504 that may be machine-read or manually read and entered into a system as an authentication code.

Moreover, in addition to a self-destructive code device, a rechargeable battery device may include one or more additional authentication codes. Incorporating one or more additional authentication codes into a rechargeable battery device may allow further validation, for example, to prevent recycled or reworked battery cells into an OEM rechargeable battery package or by attempting to reuse a recycled OEM rechargeable battery device if an authentication code from an authentic rechargeable battery device could be obtained.

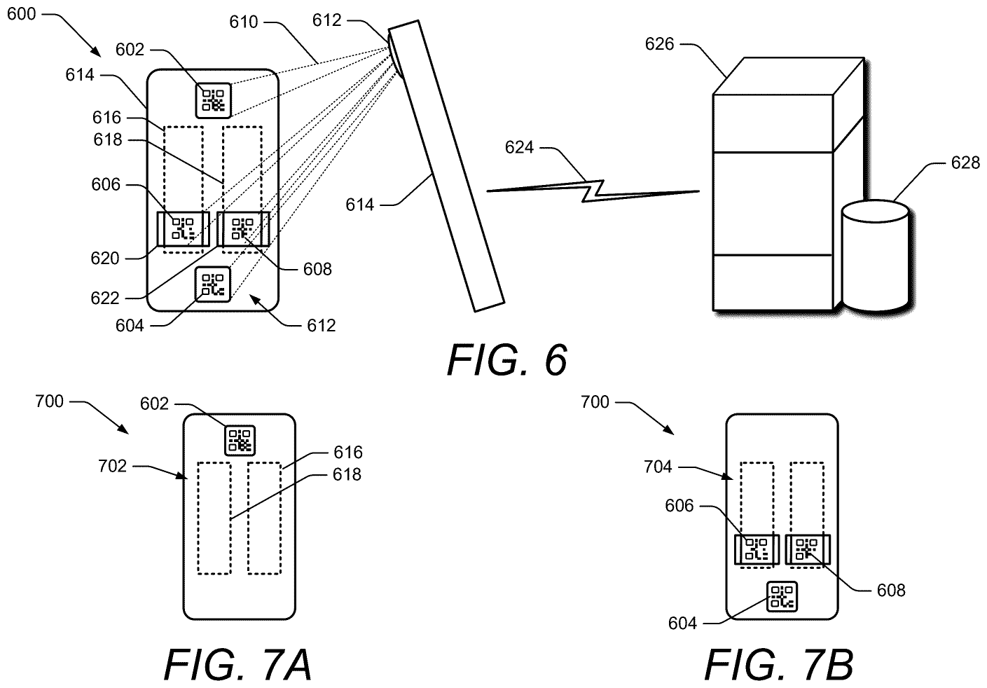

FIG. 6 shows a rechargeable battery device 600 that includes multiple authentication codes 602, 604, 606, and 608. The rechargeable battery device 600 is shown while being scanned, as represented by the dotted lines 610, with a camera or other photographic device 612 of a mobile telephone 614. For example, the authentication code 602 may include an authentication code presented by a self-destructive code device, such as previously described with reference to FIGS. 1-4B. In addition to the authentication code presented by the self-destructive code device 602, a battery pack authentication code 604 may be disposed on a surface 612 of a battery pack 614 that encompasses one or more battery cells 616 and 618 of the rechargeable battery device 600. Battery cell authentication codes 606 and 608 may be disposed on each of the battery cells 616 and 618, respectively. The battery cell codes 606 and 608 may be accessed, scanned, or read through openings 620 and 622 formed in the surface 612 of the battery pack 614 over each of the battery cells 616 and 618, respectively.

When scanned 610 by the camera or other photographic device 612, the authentication codes 602, 604, 606, and 608 may be communicated over a network 624 with an authentication system 626 that maintains an authentication database 628. The database 628 may be configured to receive records that, upon manufacture of the rechargeable battery device, associate each of the authentication codes 602, 604, 606, and 608 with each other. Thus, the authentication system 626 may authenticate the rechargeable battery device 600 only when the authentication code 602 presented by the self-destructive code device is authentic and that the one or more additional codes 604, 606, and/or 608 were associated with the authentication code 602. Thus, someone trying to pass off a rechargeable battery device would have to be able to present a non-OEM device with a complete set of the authentication codes 602, 604, 606, and 608.

Multiple authentication codes 602, 604, 606, and 608 may be presented on one face of the rechargeable battery device 600, as shown in FIG. 6, or the multiple authentication codes 602, 604, 606, and 608 may be presented on multiple faces of a rechargeable battery device 600. For example, FIGS. 7A and 7B show a rechargeable battery device 700 on which the authentication codes 602, 604, 606, and 608 are presented on opposing faces. FIG. 7A shows a first face 702 of the rechargeable battery device 700 that presents the authentication code 602. FIG. 7B shows a second face 704 of the rechargeable battery device 700 that presents the authentication codes 604, 606, and 608. Any combination of the authentication codes 602, 604, 606, and/or 608 may be presented on more than two or more faces of the rechargeable battery device 700 and/or any combination of the authentication codes 602, 604, 606, and 608 may appear on the different faces 702 or 704 of the rechargeable battery device 700.

### Authentication Process to Verify Use of Rechargeable Battery Device

As previously described, to protect an electronic device and/or its user, it may be desirable to verify that a rechargeable battery device is authenticated for use with the electronic device. An authentication system 114 (see FIG. 1) or 626 (see FIG. 6) may be used to verify that a rechargeable battery device is authenticated for use with the electronic device 106 (see FIGS. 1 and 2B-2C). The authentication codes may be scanned and communicated to the authentication system 114 or 626 by scanning or otherwise communicating the authentication codes to the authentication system 114 or 626. If the authentication system 114 or 626 determines that the one or more authentication codes associated with the rechargeable battery device are not authenticated, the electronic device 106 may be configured to restrict the function of the rechargeable battery device to reduce power drain, restrict rapid charging modes, and/or other functions that a non-OEM battery may not be verifiably capable to support.

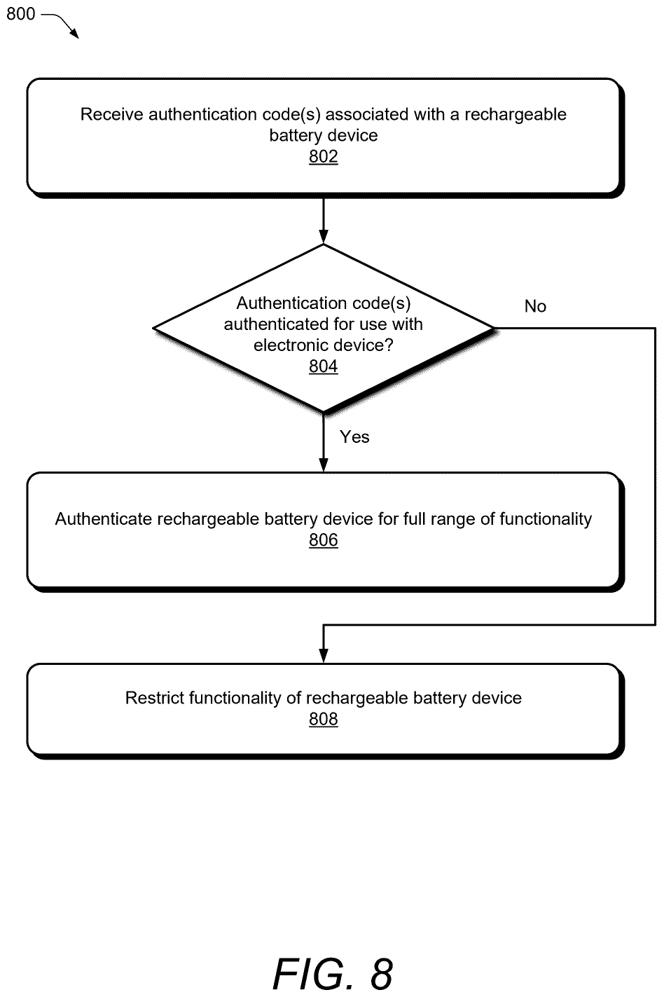

FIG. 8 shows a flow diagram of an example method 800 of a FIG. 8 is a flow diagram of managing functionality of a rechargeable battery device according to one or more authentication codes as previously described with reference to FIGS. 1 and 6. At a block 802, one or more authentication codes associated with a rechargeable battery device are received. In aspects, as described with reference to FIGS. 1 and 6, the one or more authentication codes are received at an electronic device and/or communicated to an authentication system to determine if the authentication codes are authenticated for use with an electronic device. At a block 804, it is determined if the one or more authentication codes are authenticated for use with the electronic device. Whether the one or more authentication codes are authenticated may be determined, for example, by determining if an authentication code assigned to a self-destructive code device has already been used, if multiple authentication codes presented are properly associated with each other in authentication database, etc.

If it is determined at the block 804 that the one or more authentication codes are authenticated for use with the electronic device, at a block 806, the rechargeable battery device is authenticated for a full range of functionality. However, if it is determined at the block 804 that the one or more authentication codes are not authenticated for use with the electronic device, at a block 808, functionality of the rechargeable battery is restricted.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations of systems and techniques for a self-destructive code device for a rechargeable battery device have been described in language specific to certain features and/or methods, the subject of the appended claims is not necessarily limited to the specific features or methods described. Rather, the specific features and methods are disclosed as example implementations of systems and techniques for a self-destructive code device for a rechargeable battery device.

What is claimed is:

1. A system comprising:
a rechargeable battery device authenticated for use with an electronic device;
an authentication code associated with the rechargeable battery device, the authentication code usable to verify that the rechargeable battery device is authenticated for use with the electronic device; and
a self-destructive code device attachable to the rechargeable battery device configured to:
present the authentication code; and
cause the authentication code to become unusable after the rechargeable battery device is deployed for use with the electronic device.

2. The system of claim 1, wherein the authentication code is associated with the rechargeable battery device in an authentication system, the authorization system configured to verify that the rechargeable battery device associated with the authentication code is authenticated for use with the electronic device.

3. The system of claim 2, wherein the authentication code is uniquely associated with the rechargeable battery device.

4. The system of claim 2, wherein the authentication code includes a machine-readable code scannable by a photographic device configured to communicate with the authentication system to verify that the rechargeable battery device associated with the authentication code is authenticated for use with the electronic device.

5. The system of claim 4, wherein the electronic device includes a mobile telephone or other electronic device and the photographic device includes a camera included in the mobile telephone or in another mobile telephone or the other electronic device.

6. The system of claim 2, further comprising one or more additional authentication codes associated with the rechargeable battery device, the authentication system being configured to verify that the one or more additional authentication codes also indicate that the rechargeable battery device is authenticated for use with the electronic device.

7. The system of claim 6, wherein the one or more additional authentication codes include:
a battery pack code disposed on a surface of the rechargeable battery device; or
one or more battery cell codes included on one or more battery cells included in the battery pack, the surface of the battery pack including openings through which each of the one or more battery cell codes is scannable.

8. The system of claim 7, wherein the authentication code and one or more of the additional authentication codes may be presented on one face of the rechargeable battery device or on multiple faces of the rechargeable battery device.

9. The system of claim 2, wherein the authentication system is configured to cause the electronic device to restrict functionality of the rechargeable battery device if the authentication code is not authenticated for use with the electronic device.

10. The system of claim 1, wherein the authentication code includes a quick response (QR code), a bar code, or a machine-readable alphanumeric code.

11. The system of claim 1, further comprising a cover layer configured to be removably attachable to a first surface of the self-destructive code device to conceal the authentication code prior to the rechargeable battery device being deployed upon removal from delivery packaging or installation in the electronic device.

12. The system of claim 11, wherein the self-destructive code device includes an adhesive member having a first surface configured to attach the self-destructive code device to the rechargeable battery device and a second surface configured to secure the rechargeable battery device to a battery compartment of the electronic device.

13. The system of claim 12, wherein the adhesive member is configured to deform or tear upon removal from the battery compartment of the electronic device to prevent the authentication code from being usable after removal.

14. The system of claim 12, wherein the adhesive member includes a pressure-sensitive adhesive material.

15. The system of claim 11, wherein:
the cover layer is attached to or incorporated in a carrier layer included in the delivery packaging for the rechargeable battery device; and
the cover layer is removed from the self-destructive code device when the rechargeable battery back is removed from the carrier layer.

16. The system of claim 11, wherein the authentication code begins to fade, darken, discolor, and/or disappear upon removal of the cover layer from the self-destructive code device.
